(19) United States
(12) Patent Application Publication
(10) Pub. No.: US 2015/0107959 A1
(43) Pub. Date: Apr. 23, 2015

(54) Product Transfer System And Related Methods

(71) Applicant: R.A Jones & Co., Covington, KY (US)

(72) Inventors: William E. Engelhardt, Morning View, KY (US); Paul A. Frederick, Harrison, OH (US); R. Todd Gatman, Burlington, KY (US); Matthew B. Good, Alexandria, KY (US); Robert M. Kalany, Florence, KY (US); Anthony B. Salvato, Cincinnati, OH (US)

(21) Appl. No.: 14/519,905

(22) Filed: Oct. 21, 2014

Related U.S. Application Data
(60) Provisional application No. 61/894,123, filed on Oct. 22, 2013.

(51) Int. Cl. B65G 47/28; B65G 47/244; B65G 17/16; B65G 17/00

(52) U.S. Cl. CPC B65G 47/28; B65G 17/005; B65G 47/244; B65G 17/16
USPC 198/377.01; 198/418; 198/701

(57) ABSTRACT

System and methods for providing a transfer of products with the ability to match speed and position, and to change the incoming products from a narrow-edge-leading orientation to broad-edge-leading orientation, and to convey the products to a location to be grouped and transferred.

### CROSS-REFERENCE TO RELATED APPLICATION

This application claims the priority of U.S. Provisional Patent Application Ser. No. 61/894,123, filed Oct. 22, 2013 (pending), entitled “FLOW WRAPPED PRODUCT TRANSFER,” the disclosure of which is hereby expressly incorporated by reference herein in its entirety.

### TECHNICAL FIELD

The present invention relates generally to transferring, conveying, or handling of products, and more particularly to product transfer systems and methods.

### BACKGROUND

When handling products with packaging equipment, it is sometimes necessary to obtain a product from upstream equipment, where the product is traveling at a constant speed, a fixed pitch, and in a narrow-edge-leading orientation. Often, however, the pitch may vary or the product may be absent due to having been rejected upstream. Once the product is captured, it is often necessary to move the product with a particular pitch and speed, and to reposition the product from a narrow-edge-leading orientation to a broad-edge-leading orientation.

One example of a known method for transferring products includes using a smart belt system, positioned upstream, to place incoming products on pitch. Once the products are on pitch, a turret wheel then grabs a product and spins the product 90 degrees, thereby changing the product's orientation from a narrow-edge-leading orientation to a broad-edge-leading orientation. After the orientation of the product is changed, the turret then places the product into a pocket, from which downstream equipment then picks and places the product into a carton.

Another example of a known method for transferring products including using a conveyor that conveys incoming product, in a narrow-edge-leading orientation, to a flighted belt. The flighted belt waits with an open pocket for product to arrive. Once a pocket has been filled by an incoming product, the flighted belt then indexes, thereby presenting a new open pocket to be filled by a next incoming product. In such systems, the flighted belt is positioned perpendicular to the conveyor. Whereas the incoming products may be conveyed along the conveyor in a narrow-edge-leading orientation, upon transfer to the perpendicularly positioned flighted belt, the products are then moved by the belt in a broad-edge-leading orientation.

Additional examples of known system and methods for transferring products are disclosed in U.S. Pat. Nos. 8,783,000, 7,134,258, and 6,390,276, the disclosures of which are hereby expressly incorporated by reference herein in their entirety.

There remains a need for improvements in known product transfer systems and methods.

### SUMMARY

The present invention provides improvements to overcome shortcomings of known product transfer systems and methods. While the invention will be described in connection with one or more embodiments, it will be understood that the invention is not limited to these embodiments. On the contrary, the invention includes all alternatives, modifications, and equivalents as may be included within the spirit and scope of the present invention.

In one embodiment of the invention, a method is provided for transferring products from a narrow-edge-leading orientation to a broad-edge-leading orientation, where there is no change in velocity between arriving products and a product vessel moving along a direction of product travel.

In another embodiment of the invention, a method is provided for collecting individual products that arrive asynchronously and subsequently organizing the individual products into groups prescribed by a downstream transfer.

In yet another embodiment of the invention, a system for transferring products includes a plurality of moving magnet linear motors and a plurality of independently controllable moving elements, each moving element having a product vessel coupled to it.

Various additional features and advantages of the invention will become more apparent to those of ordinary skill in the art upon review of the following detailed description of the illustrative embodiments taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of a product transfer system in accordance with one embodiment of the present invention.

FIG. 2 is a top elevation view of the product transfer system of FIG. 1.

FIG. 3 is a side elevation of the product transfer system of FIG. 1.

### DETAILED DESCRIPTION

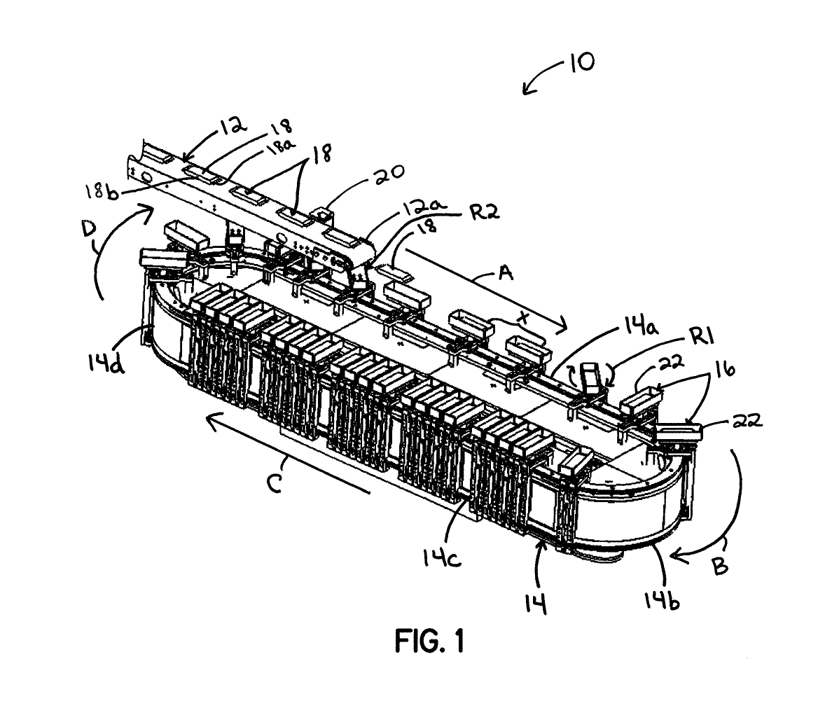

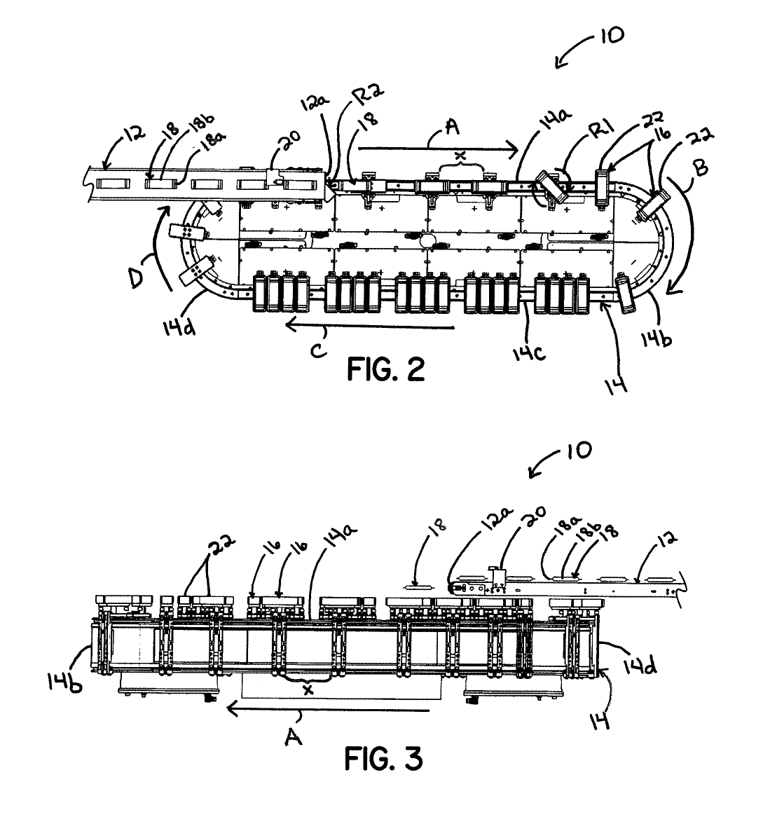

Referring now to the figures, FIGS. 1-3 show an exemplary product transfer system 10 in accordance with one embodiment of the present invention. As shown, the product transfer system 10 includes a launch conveyor 12, an oval track 14 positioned beneath the launch conveyor 12, and a plurality of carts 16 operatively coupled to the oval track 14. Each of the carts 16 is independently controllable to be driven along the oval track 14, for example by linear motors (not shown), for transferring products 18 received from the launch conveyor 12. As shown, the oval track 14 may include, in continuous series, a first leg 14a, a first turn 14b, a second leg 14c opposed from the first leg 14a, and a second turn 14d opposed from the first turn 14b. Persons skilled in the art will appreciate that the system 10 may be adapted to tracks of various alternative configurations.

The launch conveyor 12 conveys the products 18 from upstream equipment (not shown), positioned upstream from the conveyor 12, to the carts 16 positioned on the oval track 14. Each product 18 is carried by the launch conveyer 12 at a known speed, and passes by a photo eye 20. The photo eye 20 identifies the conveyed product 18 and outputs corresponding data to the system 10. The system 10 compares this data corresponding to the conveyed product 18 to positional data corresponding to a nearest empty cart 16 approaching the launching end 12a of the conveyor 12. Based on this comparison, the system 10 determines an appropriate cart trajectory for the approaching cart 16, so that the approaching cart 16 may be controlled to track synchronously with the conveyed product 18 when it is launched. In this regard, each cart 16 is controlled independently from every other cart 16, such that each cart 16 may be registered individually to each incoming product 18 carried by the launch conveyor 12.

Upon reaching the launching end 12a of the conveyor 12, the product 18 is launched with a known product trajectory. Simultaneously, the cart 16 is controlled to track the trajectory of the launched product 18, so that the cart 16 may ultimately capture the launched product 18. In this regard, each cart 16 is equipped with a rotatable vessel 22 configured to capture, retain, and transport a launched product 18. In particular, the rotatable vessel 22 is operatively coupled and rotatable relative to the cart 16. In one embodiment, the rotatable vessel 22 may be in the form of a rotatable bucket or tray, such as those disclosed in U.S. Pat. Nos. 6,390,276 and 8,783,000, incorporated by reference above. In other embodiments, the rotatable vessel 22 may include any other suitable rotatable mechanism.

When the product 18 is captured in the rotatable vessel 22, the vessel 22 is positioned in a first orientation in which a length of the vessel 22, and a corresponding length of the product 18 carried thereby, is oriented substantially parallel to a path of travel of the cart 16 along the oval track 14. After capturing the launched product 18, the cart 16 continues to advance, controlled independently from the remaining carts 16, along the first leg 14a of the oval track 14 toward the first turn 14b, as indicated by directional arrow A.

Before the cart 16 reaches the first turn 14b, the vessel 22 is rotated approximately 90 degrees, as indicated at R1, into a second orientation in which the length of the vessel 22, and the corresponding length of the product 18 carried thereby, is oriented substantially perpendicular to the path of travel of the cart 16 along the oval track 14. The cart 16, with the vessel 22 in the second orientation, then travels around the first turn 14b of the oval track 14, as indicated by directional arrow B.

As shown in the illustrated embodiment, the product 18 may be launched from the launch conveyer 12, and captured by the vessel 22 of the cart 16, such that a narrow edge 18a of the product is leading (a “narrow-edge-leading orientation”). In this regard, the first orientation of the rotatable vessel 22 may maintain the captured product 18 in an orientation such that the narrow edge 18a of the product remains leading while the product 18 is carried by the cart 16 along the path of travel. The second orientation of the rotatable vessel 22 may then orient the product 18 such that a broad edge 18b of the product 18 is leading (a “broad-edge-leading orientation”) while the product 18 is carried by the cart 16 along the path of travel. Moreover, the plurality of carts 16 may be controlled so as to provide an inter-cart spacing X (referred to as “pitch”) that is sufficient to avoid collision of a first product 18 carried by a first cart 16 with a second product 18 carried by an adjacent second cart 16 following immediately behind the first cart 16, when the second product 18 is rotated from the first orientation to the second orientation by its respective vessel 22.

Upon entering the second leg 14c of the oval track 14, the cart 16 queues up with adjacent carts 16 containing products 18. At this stage, the product 18 carried by the cart 16 may be transferred by downstream equipment (not shown) from the vessel 22 to a downstream location, such as a carton, for example. Once this transfer of the product 18 has been completed, the empty cart 16, having an empty vessel 22, accelerates along the second leg 14c of the oval track 14, and travels around the second turn 14d, back toward the first leg 14a, as indicated by directional arrows C and D, respectively. As the empty cart 16 exits the second turn 14d, the vessel 22 is rotated approximately 90 degrees back to the first orientation, as indicated at R2, and then queues up with an adjacent cart 16, ready to capture a new conveyed, incoming product 18 to be launched from the launch conveyor 12.

As described above, each cart 16 of the system 10 is controllable and movable along the oval track 14 independently from each of the remaining carts 16. Accordingly, the rate of movement and positioning of each cart 16 along the oval track 14 may be controlled independently from that of each of the other carts 16.

Additionally, the rotational orientation of the vessel 22 of each cart 16 is controllable independently from that of each of the other carts 16. Accordingly, the product transfer system 10 advantageously enables transfer of products with improved degrees of efficiency and accuracy.

While the present invention has been illustrated by the description of a specific embodiment thereof, and while the embodiment has been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of the general inventive concept.

What is claimed is:

1. A method for transferring product from a narrow edge leading orientation to a broad edge leading orientation where there is no change in velocity between the arriving product and the product bucket in the direction of product travel.

2. A method as in claim 1 where if a change in velocity is required, it is done gently in a prescribed and predictable manor.

3. A method for collecting individual products that arrive asynchronously and subsequently organizing the individual products into groups prescribed by the downstream transfer.

4. A method as in claim 3 where the product groups are infinitely variable and not fixed by tooling.

5. An apparatus made up of moving magnet linear motors with multiple, independently controlled moving elements. Each moving element has a product bucket fixed to it.

6. An apparatus as in claim 5 where the product bucket is rotatably fixed to the moving element.

7. An apparatus as in claim 6 where the bucket and product can be selectively rotated to create various product group patterns of odd and even rotation.

8. An apparatus as in claim 6 where the bucket and product can be selectively not rotated to create various patterns of rotated and non-rotated product group patterns
